(19) United States
(12) Patent Application Publication
(10) Pub. No.: US 2003/0162151 A1
(43) Pub. Date: Aug. 28, 2003

(54) Display responsive learning apparatus and method for children

(76) Inventors: Natasha Berling, Cranston, RI (US); Jennifer Long, Providence, RI (US); David A. Visnick, East Providence, RI (US)

Correspondence Address: Perry J. Hoffman, Michael Best & Friedrich, LLC, 19th Floor, 401 N. Michigan Avenue, Chicago, IL, 60611, US

(21) Appl. No.: 10/346,702

(22) Filed: Jan. 17, 2003

Related U.S. Application Data
(63) Continuation-in-part of application No. 09/855,888, filed on May 15, 2001, now Pat. No. 6,517,355.

(51) Int. Cl. G01S 1/00

(52) U.S. Cl. 434/5

(57) ABSTRACT

A display-responsive learning apparatus that includes a moveable display panel supported in a housing. The display panel includes a front opaque panel attached to circuit board having a plurality of light-emitting diodes (LEDs). A sensor is positioned behind the moveable display panel. In response to a user moving the display panel, the sensor provides a signal to a controller to provide one of a plurality of pre-programmed visual representations to the user. The visual representations include illuminating various patterns of the LEDs that show a successive series of letters of the alphabet, a successive series of numbers, or a smiling face with lips that move in combination with an output of audio sounds from a speaker. The enhanced interactive display panel and visual displays provide an improved method for educational learning and increases its play value.

### CROSS-REFERENCE TO RELATED APPLICATIONS

This present application is a continuation-in-part of co-pending U.S. patent application Ser. No. 09/855,888 filed on May 15, 2001.

### BACKGROUND OF THE INVENTION

1. Field of the Invention

The present invention relates to a learning apparatus and method for children, and more specifically, to a display-responsive learning apparatus.

2. Description of the Related Art

A variety of a educational learning apparatus (ELAs) with responsive displays designed for children are known. Two important influences on the consumer demand for these ELAs is their ability to interact and their play value with children.

One type of ELA with a responsive display is a magnetically responsive writing device that allows a user to draw or write on a tablet by using a magnetically attractive stylus and magnetic writing media are known in the art. One such ELA, also known as a magnetophoretic display panel, is disclosed in U.S. Pat. No. 4,143,472 to Murata for “Displaying Magnetic Panel And Its Display Device,” issued Mar. 13, 1979. The display panel includes a plurality of cells sandwiched between two substrates, each cell being filled with a liquid dispersion that comprises magnetic particles, a dispersion medium, a colorant and, optionally, a thickener. When a user applies a magnetic stylus to either substrate, the magnetic particles are attracted by the magnetic force of the stylus and move toward the surface of the liquid adjacent the substrate to produce a visual representation. The visual representation is formed by the difference in contrast between the color of the liquid dispersion and that of the magnetic particles. The surface of the substrate can thereafter be be “erased” by passing a magnet across the other surface to pull the magnetic particles away from the substrate writing surface.

Another type of ELA with a responsive display is disclosed in U.S. Pat. No. 5,813,861 to Wood for “Talking Phonics Interactive Learning Device,” issued Sep. 29, 1998. Wood discloses an interactive learning device having a laid open book format with keys in the form of raised letters of the alphabet, an audio speaker, and a speech processor circuit. The learning device receives a card that spells out a word. Upon pressing the keys associated with the letters that spell the word, the speech processor circuit provides an audio sound of the word and/or letter by letter. This type of ELA requires complicated interaction that can be cumbersome for children, thereby lowering its play value. Additionally, this type of device lacks the visual stimulation available under modern technology that can motivate children to play with the ELA.

More recent advancements in the field of ELAs have been enhancements of the visual displays. One example of such an ELA is disclosed in U.S. Pat. No. 6,146,146 to Koby-Olson for “Learning Device For Children,” issued Nov. 14, 2000. Koby-Olson discloses an interactive learning device that includes a housing with multiple switches, a speaker, and one or more display screens. An image of the letter of the alphabet is associated with each switch. A processor communicates with each switch, the speaker and the display screens. In response to pressing a switch, the processor causes the speaker to produce an audio sound of the letter associated with the switch and cause the display screen to trace an image of the letter. Like the other known types of ELAs described above, this ELA requires complicated interaction from the user and lacks today's technological advancements in visual displays to provide the desired play value.

In light of the limitations of the related art described above, a desire exists for less cumbersome interactive learning devices having enhanced interactive visual features that motivates learning and increases its play value for children.

### SUMMARY OF THE INVENTION

The present invention provides an innovative learning devices having an eloquent means for interacting with children and innovative visual representations that enhances its popularity and play value.

In one embodiment, the invention provides a display-responsive learning apparatus, comprising a housing having an aperture, an illumination device positioned in the aperture and including a plurality of visual indicators operable in providing a plurality of visual representations to a user, a display panel located in front of the illumination device and rotatable about a hinge member, the display panel including an opaque substrate contrasting the plurality of visual representations of the illumination device, a sensor positioned to detect moving the display panel and operable in providing a signal in response to the user moving the display, and a controller electrically connected to the sensor and illumination device, where in response to receiving an electrical signal from the controller, the controller activates the illumination device to provide at least one of the plurality of visual representations to the user.

In another embodiment, the invention provides a method for learning from display-responsive display apparatus, the method comprising the acts of moving a display panel supported in a housing by a hinge, detecting a movement of the display panel, storing a plurality of pre-programmed visual representations, selecting one visual representation from the plurality of pre-programmed visual representations; and illuminating the one visual representation in response to detecting movement of the panel.

Briefly summarized, the present invention provides a display-responsive learning apparatus that includes a moveable display panel supported in a housing. The display panel includes a front opaque panel attached to circuit board having a plurality of light-emitting diodes (LEDs). A sensor is positioned behind the moveable display panel. In response to a user moving the display panel, the sensor provides a signal to a controller to provide one of a plurality of pre-programmed visual representations to the user. The visual representations include illuminating various patterns of the LEDs that show a successive series of letters of the alphabet, a successive series of numbers, or a smiling face with lips that move in combination with an output of audio sounds from a speaker. The enhanced interactive display panel and visual displays provide an improved method for educational learning and increases its play value.

As is apparent from the above, it is an aspect of the invention to provide a display-responsive educational learning apparatus and method for children. Other features and aspects of the invention will become apparent by consideration of the detailed description and accompanying drawings.

### BRIEF DESCRIPTION OF THE DRAWINGS

In setting forth and explaining the embodiments of the invention in detail herein, it will be appreciated that the invention is not limited in its application to the details of construction and the arrangement of components set forth in the following description or illustrated in the following drawings. The invention is capable of other embodiments and of being practiced or of being carried out in various ways. To this end, the invention is set forth in the appended claims.

FIG. 1 is perspective view of a magnetically responsive writing device according to one embodiment of the invention;

FIG. 2 is a front view of the magnetically responsive writing device of FIG. 1;

FIG. 3 is a front view of the magnetically responsive writing device of FIG. 1 with magnetic stylus removed;

FIG. 4 is a side view of the magnetically responsive writing device of FIG. 3;

FIG. 5 is a front view of the magnetically responsive writing device of FIG. 1 with the front housing and magnetic tablet removed;

FIG. 6 is a rear view of the magnetically responsive writing device of FIG. 1 with the rear housing and output device removed;

FIG. 7 is an exploded perspective view of the display panel and magnetic eraser;

FIG. 8 is a perspective view of the display panel and magnetic eraser together;

FIG. 9 is a side, cross-sectional view of the magnetic eraser of FIG. 8 taken along lines 9-9 in a non-rotated position;

FIG. 10 is a side, cross-sectional view of the magnetic eraser of FIG. 9 in a rotated 10 position;

FIG. 11 is a side, cross-sectional view of the hinge member of the magnetic tablet of FIG. 8 taken along lines 11-11 in a non-rotated position;

FIG. 12 is a side, cross-sectional view of the hinge member of the magnetic tablet of FIG. 11 in a rotated position;

FIG. 13 is a front view of the magnetically responsive writing device of FIG. 1;

FIG. 14 is a side, cross-sectional view of the magnetically responsive writing device of FIG. 13 taken along lines 14-14 in a non-actuated position;

FIG. 15 is a side, cross-sectional view of the magnetically responsive writing device of FIG. 14 in an actuated position;

FIG. 16 is a perspective view of a second embodiment of a display-responsive learning apparatus;

FIG. 17 is a side, cross-sectional view of the embodiment illustrated in FIG. 16 taken along the lines 17-17;

FIG. 18 is a rear, cross-sectional view of the embodiment illustrated in FIG. 17 taken along the lines 18-18;

FIG. 19 is a front view of the second embodiment illustrated in FIG. 16, displaying a visual representation of letter of the alphabet;

FIG. 20 is a front view of the second embodiment illustrated in FIG. 16, displaying a visual representation of a smiling face with lips closed;

FIG. 21 is front view of the second embodiment illustrated in FIG. 16, displaying a visual representation of a smiling face with lips open to simulate speaking;

FIG. 22 is a schematic diagram of an exemplary control system for the display-responsive learning apparatus;

FIG. 23 is a flow diagram for one embodiment of a method for learning with the display-responsive learning apparatus; and

FIG. 24 is a flow diagram for one embodiment of a method for interacting with the apparatus.

### DETAILED DESCRIPTION

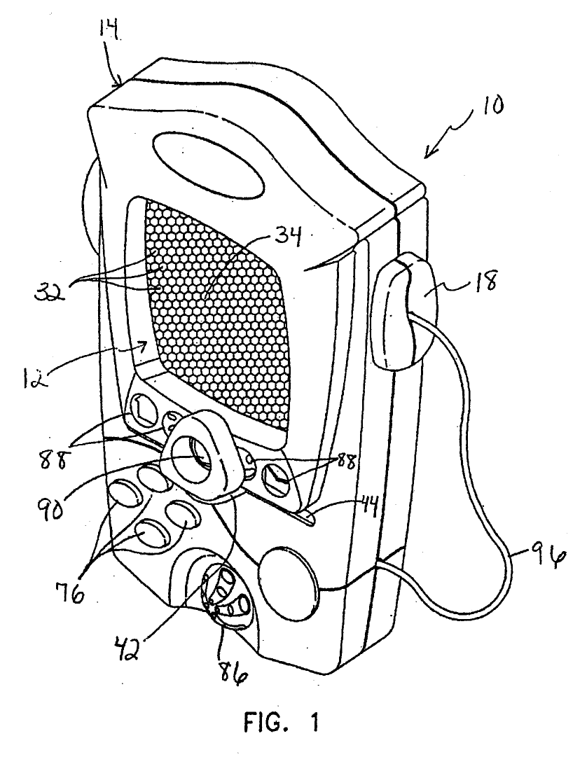

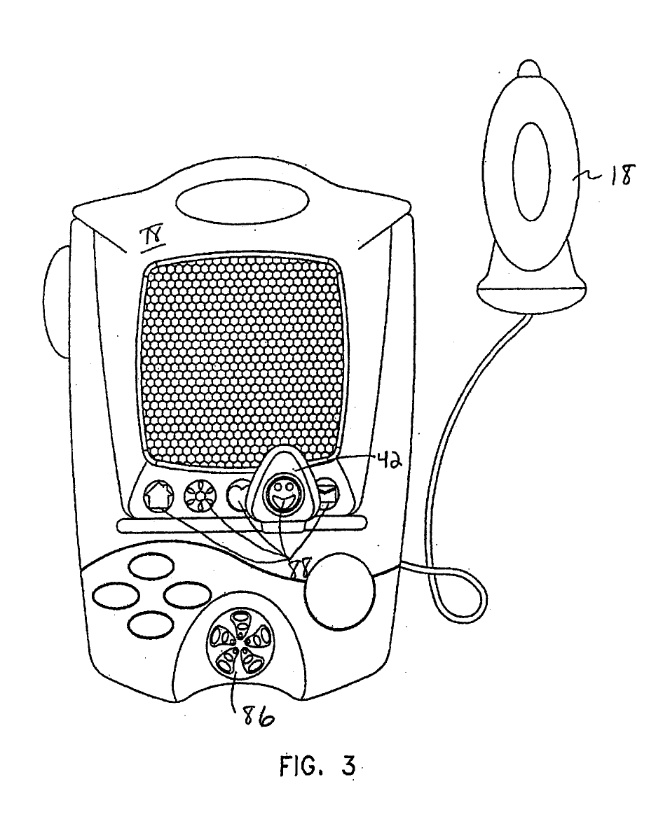

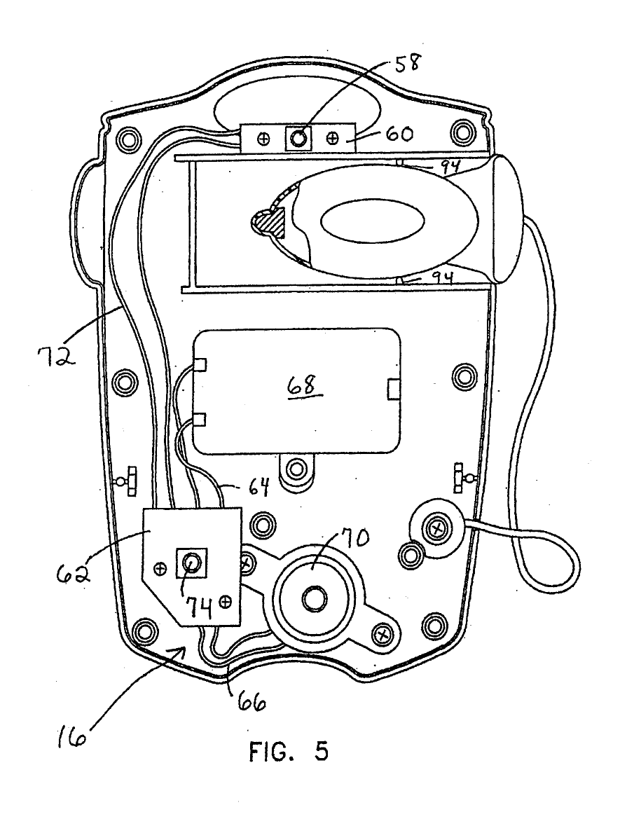

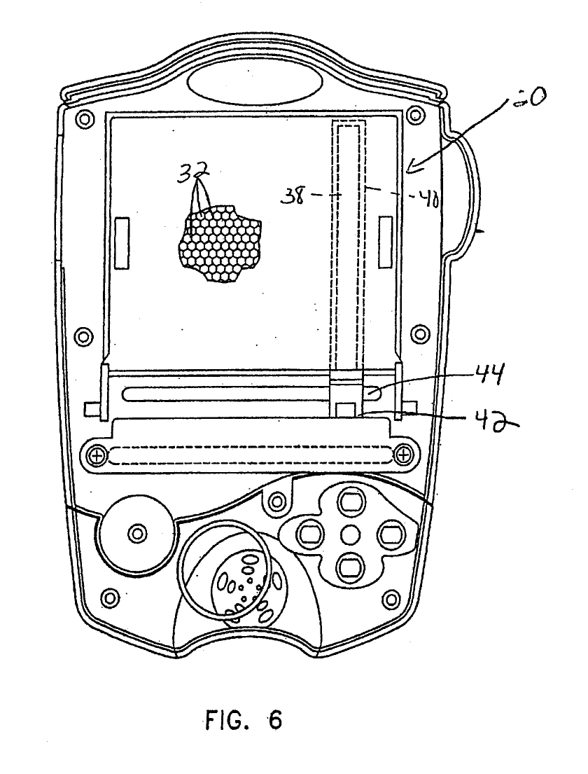

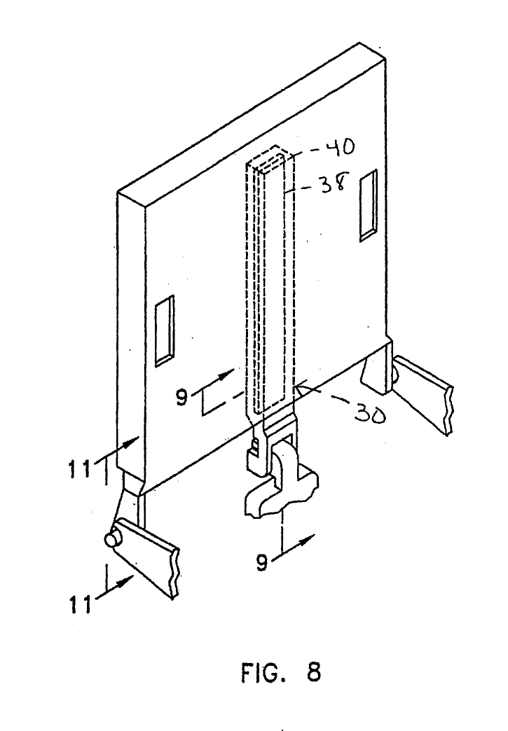

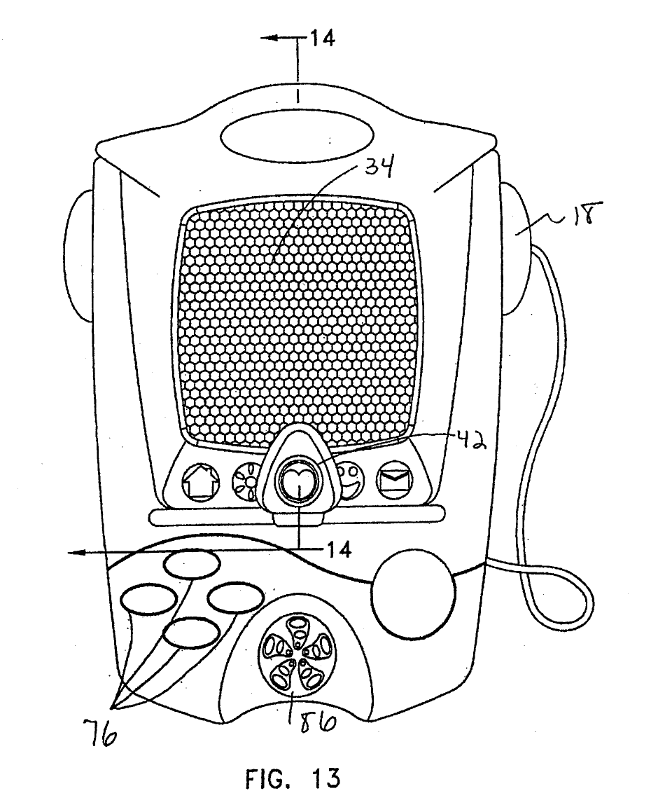

The various embodiments of the invention described herein relate to display responsive learning apparatus that include moveable display panels supported in a housing, as described in detail below. The enhanced interactive display panel and visual displays provide improved educational learning apparatus (ELAs) facilitating improved play value. An embodiment of a magnetic writing device 10 includes a magnetically responsive tablet 12 and an automated output 16, is illustrated in FIGS. 1-15. The magnetic tablet 12 is preferably rotatably supported within a housing 14, and is operatively connected to the output device 16 (FIG. 5) which is also supported within the housing. As a user presses on the magnetic tablet, it is preferably urged into contact with a switch to activate the output device, as described in greater detail below.

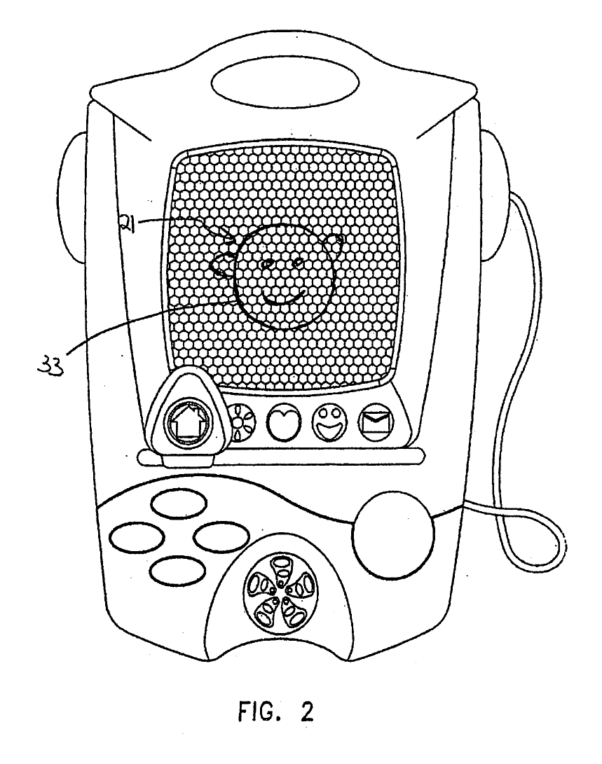

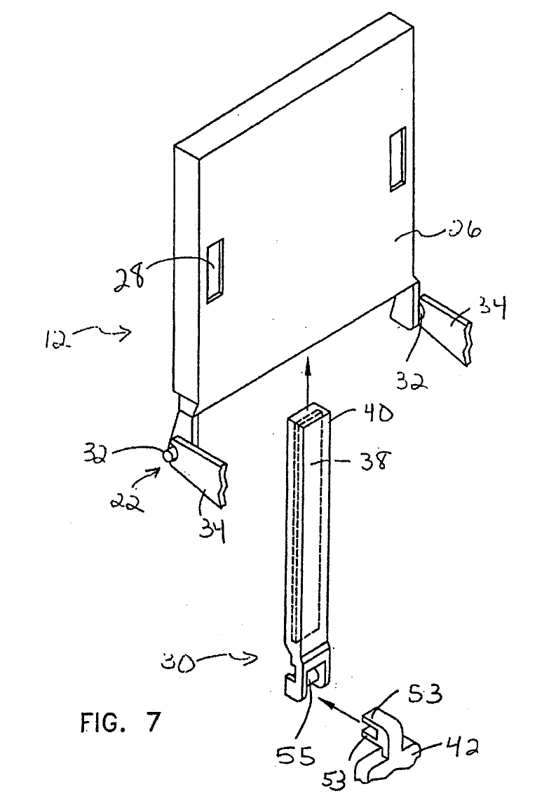

The magnetically responsive tablet 12 preferably includes a writing display panel 20 engageable by a magnetically attractive stylus 18 on at least one side thereof to produce and display an image 21 to the user (FIG. 2). The display panel 20 may be supported on mounting member 26 and a gap 28 may be disposed between the display panel and the mounting member for receiving a magnetic eraser 30 therein (FIG. 7). The display panel 20 preferably includes a plurality of cells 32 sandwiched between two substrates, each cell being filled with a liquid dispersion that includes magnetic particles 33, as is known in the art. In the present embodiment, the first or front substrate is utilized as the writing surface 34, while the second substrate is utilized as the eraser surface 36. When the user applies the magnetically attractive stylus 18 to the writing surface, the magnetic particles are attracted by the magnetic force of the stylus and move toward the surface of the liquid adjacent the writing surface to display a user created image or design. The image is formed by the difference in contrast between the color of the liquid dispersion and that of the magnetic particles, as is known in the art. The writing surface can thereafter be “erased” by passing magnetic eraser 30 across the eraser surface to pull the magnetic particles away from the substrate writing surface 34, as is also known in the art.

In the present embodiment, magnetic eraser 30 preferably includes a magnet 38 mounted within a support 40 which is rotatably supported within housing 14 (FIGS. 7-10). As described above, the magnet 38 is preferably disposed within gap 28 formed between the display panel and the mounting member and is disposed adjacent the eraser surface 36 of the display panel 20. The magnet 38 may preferably be rectangular in shape, extending between a top edge of the mounting panel to a bottom edge of the mounting panel. Support 40 may include an engagement member 42 which is slidably received within a slot 44 formed in a front member of the housing, and is moveable within the slot by the user. As the engagement member 42 is moved within the slot 44, the magnet 38 moves along the length of the eraser surface to attract the magnetic particles toward the eraser surface so as to “erase” the writing surface, as described herein above, and known in the art.

Referring now to FIGS. 7-8 and 14-15, the tablet is preferably rotatably supported within the housing 14 such that upon the stylus 18 contacting the display panel 20, the tablet rotates to activate the output device 16. In the present embodiment, the tablet may be rotatably supported by a hinge member 46 including a pair of engagement pins 48 supported on the tablet mounting member 26, the pins being secured within holders 50 supported on a rear member of the housing 14. In this manner, the mounting member 26 can rotate about pins 48 in the direction of arrow “A” as pressure is placed on the magnetic tablet, and in the reverse direction when the pressure is released. The magnetic eraser 30 may also preferably be rotatably supported within the housing 14 by a hinge 51. In the present embodiment, the hinge 51 may include a pair of prongs 53 extending from one end of the engagement member 42 and engaging pin 55 disposed on one end of the support 40, such that as the magnetic tablet is rotated in the direction of arrow “A”, the magnet 38 is likewise rotated in the same direction as indicated by arrow “B” (FIG. 10) about pin 55. Alternate methods of rotatably securing the tablet and the magnetic eraser may be utilized, as would be known to those of skill in the art.

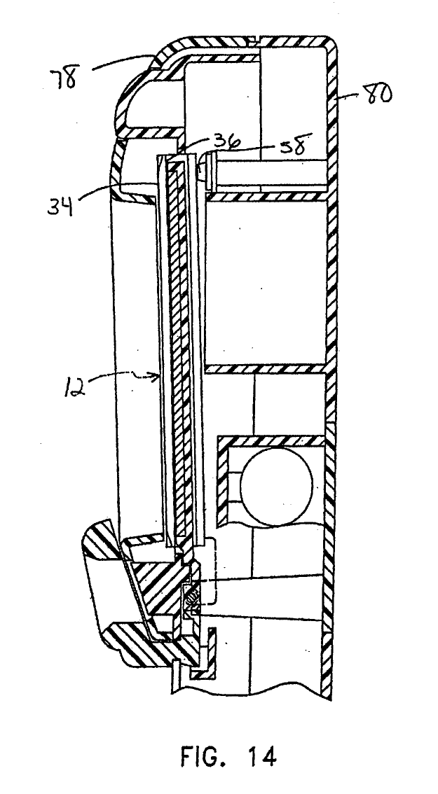

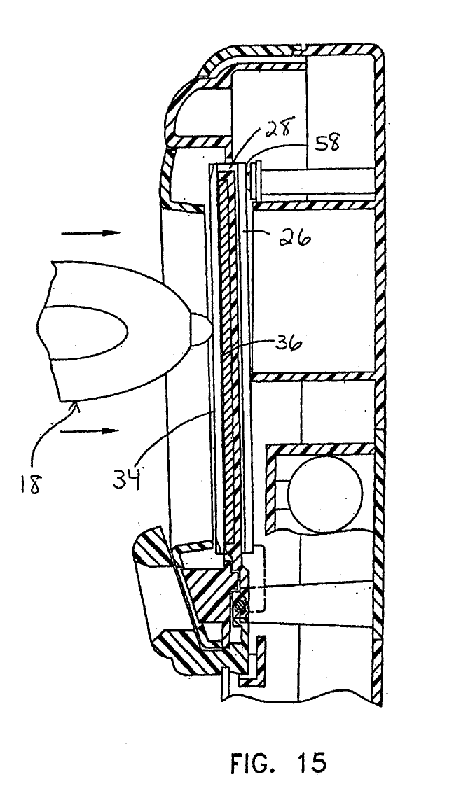

The tablet may be initially biased in a non-engaged or extended position by the hinge member 46, in which the output device is not activated (FIG. 14). As a user presses on any portion of the display panel with the stylus, the tablet preferably rotates about the hinge member 46 and engages switch 58 (FIG. 15) to activate the output device 16 and produce an automated output to the user, for example, through an audio or visual representation. In the present embodiment, the mounting member 26 preferably contacts an elastomeric switch 58 mounted to a circuit board 60 and electrically connected to a second circuit board 62 (FIG. 5), all of which are supported within the housing. As the circuit is closed, the output device produces one of number of a pre-recorded sounds which may preferably be stored on circuit board 62. Alternately, the tablet may be rotatably supported within the housing in contact with a switch such that as the user engages the tablet with the stylus, the tablet disengages the switch to activate the output device, as would be known to those of skill in the art.

The output device 16 of the present embodiment is most clearly illustrated in FIG. 5. The output device preferably includes at least one circuit board 62 containing one or more pre-recorded sounds, which is electrically connected (such as by wires 64, 66) to a power supply 68 (for example batteries) and at least one speaker 70. In the present embodiment, the output device also preferably includes switch 58 mounted to circuit board 60, which is electrically connected via wires 72 to circuit board 62 such that actuation of the switch 58 causes the output device to be activated as described above. In addition, a second switch 74 may be provided which, when actuated also activates the output device. For example, one or more buttons 76 (FIG. 1) may be provided on the writing device which, when depressed by a user, contact elastomeric switch 74 in order to activate the output device. Alternate arrangements of the output device are possible, and more than one output device may be provided, as would be known to those of skill in the art.

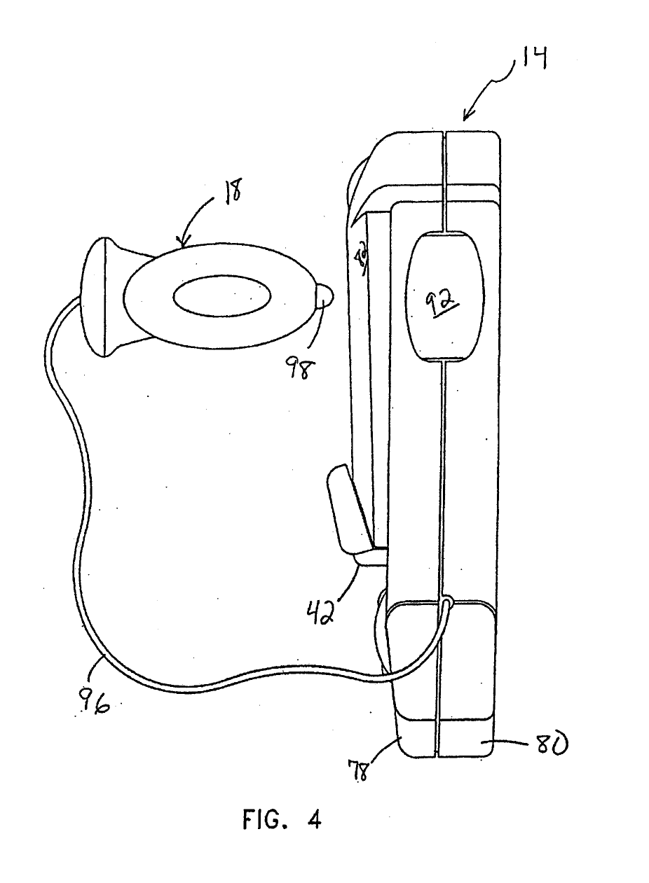

Referring now to FIGS. 1 and 4, the housing 14 which supports the writing tablet and output device will now be described. The housing preferably defines an inner cavity and includes front member 78 and rear member 80 which, when engaged, form the housing. The front member 78 preferably includes a window 82 through which the writing surface of the tablet is visible and engageable by the stylus. The front member preferably also includes the slot 44 for receiving the engagement member 42 of the magnetic eraser, the one or more buttons 76 which, when depressed by a user, also activate the output device, a speaker housing 86, and may include indica 88 visible through an opening 90 in the engagement member as the engagement member is slid within the slot. The rear member 80 preferably supports the power supply 68 on a rear surface thereof, and may support various other components of the device, including the holders 50 which engage the pins 48 supported on the tablet mounting member 26 for rotatably supporting the tablet within the cavity of the housing (not shown). The front and rear members together preferably form a recess 92 for storing the stylus 18, when the stylus is not being utilized. The stylus may be elliptical in shape, and the recess may preferably include protrusions 94 (FIG. 5) which engage and hold the stylus within the recess. The stylus may be further secured to the housing by a line 96 connected at one end to the stylus and supported at a second end within the housing so as to prevent the stylus from being accidentally lost by the user. The stylus may preferably be made of a plastic material, and includes a magnetically attractive tip 98, as is known in the art. It should be appreciated that the shape, size and location of the stylus may be readily varied, as would be known to one of skill in the art.

Use of the magnetic writing device 10 will now be described with reference to the drawings. In use, the stylus 18 is removed from within the recess 92 and the magnetically attractive tip 98 is engaged with the writing surface 34 of the tablet 12 by the user. As the user presses the tip against the writing surface, the tablet is rotated about the hinge member 46 in the direction of arrow “A”, i.e. toward the rear member 80 of the housing 14, until a portion of the tablet (for example, the mounting member 26) contacts the switch 58. As the switch is contacted and actuated by the tablet it closes the circuit to electrically activate the circuit board 62 and produce a pre-determined output, such as a pre-recorded sound. In the present embodiment, the output device produces one of number of a pre-recorded sounds which are emitted through the speaker 70. After the user contacts the writing surface with the magnetically attractive stylus, the magnetic particles are attracted by the magnetic force of the stylus and move toward the surface of the writing surface to produce a visual representation (i.e., words or drawing) created by the user. Once the user completes his or her drawing on the writing surface and the pressure is released, the tablet rotates back into its non-actuated position spaced from the switch. In this manner, the switch is no longer activated and the output device ceases producing the output. The output (such as a sound) may either be continuous (i.e. continue as long as the switch is actuated), or the output may be a single output activated each time the switch is actuated (i.e. a single output when the switch is initially actuated and another output once the switch is released and thereafter actuated again). The user may, at his or her discretion, erase the visual representation by moving the engagement member 42 within the slot 44 so as to move the magnet 38 along the length of the eraser surface to “erase” the writing surface by attracting the magnetic particles from the writing surface toward the eraser surface. If desired, the user can depress the buttons 76 on the housing to also activated the output device.

Referring to FIGS. 16-18, a second embodiment of a display learning apparatus 100 includes a housing 105 having an aperture 110, a display panel 112, an illumination device 115 that provides a visual representation discussed below, and a controller 120.

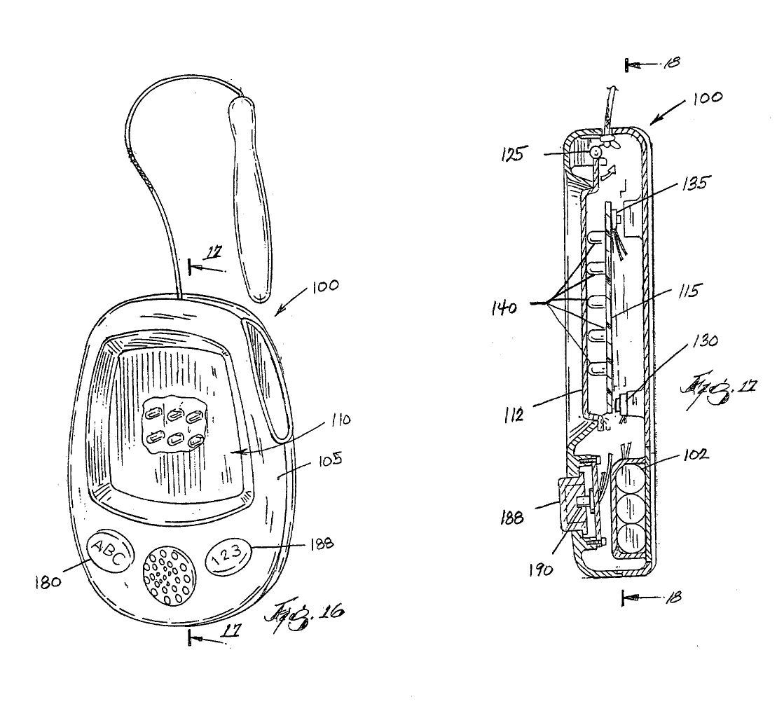

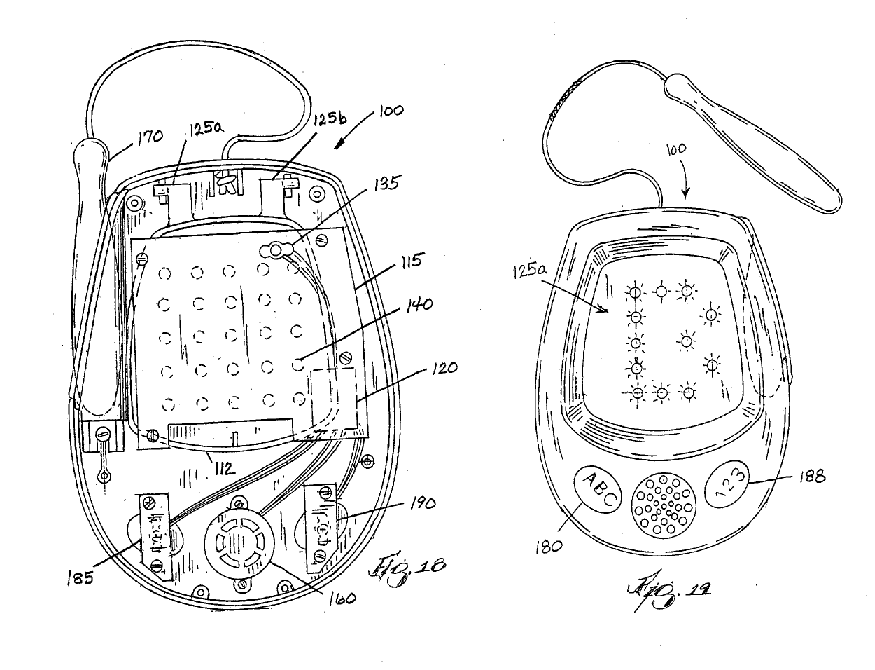

As shown in FIG. 16, the exemplary embodiment of the housing 105 is shaped similar to a writing tablet used for school. Of course, the housing 105 can include other shapes and is not limiting on the invention. As one embodiment of the housing is comprised of plastic material, but any suitable material can be used. As shown in FIGS. 17-18, one embodiment of the aperture 110 is located toward the upper part of the housing 105. The display panel 112 and illumination device 115 are located in the aperture 110 for interaction with a user.

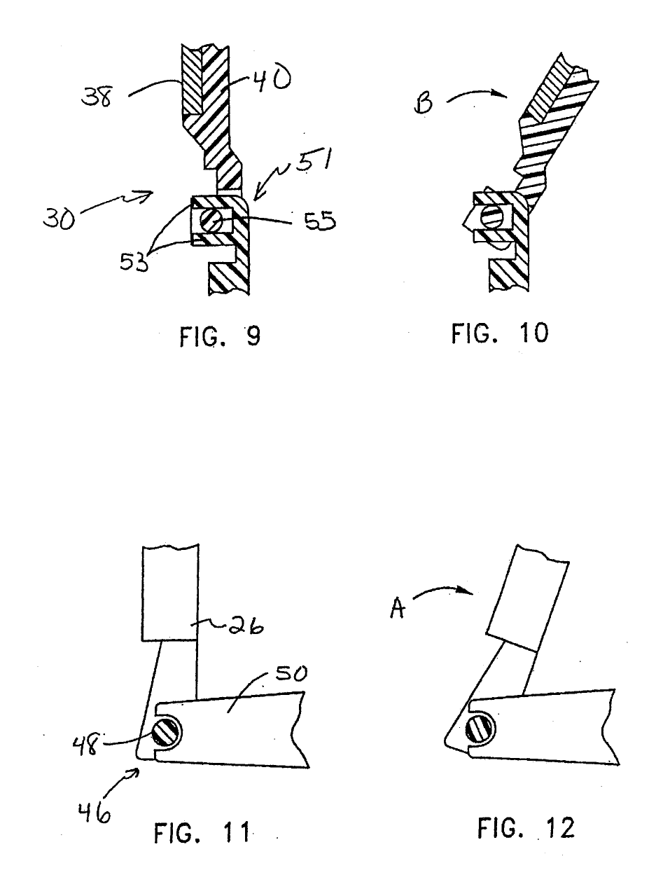

The display panel 112 is connected to the housing 105 about hinged member 125. A user interacts with the apparatus 100 by moving or pivoting the display panel 112 about its hinged member 125. An exemplary embodiment of the hinged member is shown in FIGS. 9-12. As shown in FIG. 18, a second embodiment of the hinged member 125 includes hinge components 125a and 125b located above the aperture 110. Of course, the invention is not limited by the number or location of the hinged members. In the exemplary embodiment and as shown in FIG. 18, the illumination device 115 is fixedly connected behind the display panel 112. In another embodiment, the illumination device 115 can be fixedly attached to the housing 105. Any type of fixed connection (e.g., screw, weld, etc.) known to those in the art can be used. One embodiment of the display panel 112 includes an opaque substrate contrasting the illumination device 115. The opaque substrate enhances the output of the illumination device 115 to the user. Of course, the panel can be have other contrasts (e.g., transparent) and/or colors (e.g., blue, red, etc.) and does not limit the invention.

The display panel is responsive to the user via a sensor 130 positioned behind the display panel. In one embodiment, the sensor 130 is connected to the housing 105 in the vicinity of the lower end of the display panel 112. In another embodiment, the sensor 130 can be connected to the display panel 112 to engage a contact located on the housing 105. A user moving the display panel 112 causes the panel 112 to engage the sensor 130. The sensor 130 is electrically connected to the controller 120. Upon detecting the moving panel 112, the sensor 130 provides a signal to the controller 120. In response to the signal, the controller 120 activates the illumination device 115. An exemplary embodiment of the sensor 130 is an elastomeric switch mounted to a circuit board supported by the housing 105. Of course, other types of sensors known to those in the art can be used.

In yet another embodiment, the apparatus can include a second sensor 135 electrically connected to the controller 120. The second sensor 135 can detect a second movement of the display panel 112, and in response provide a second signal to the controller 120. In one embodiment, the second signal can interrupt the visual representation 117 to the user and reset the controller 120. In another embodiment, the second signal to the controller 120 can cause a second visual representation to be provided by the illumination device 115 to the user. An exemplary embodiment of the sensor 135 is similar to the embodiment described above for sensor 130.

The illumination device 115 is electrically connected to the controller 120. One embodiment of the illumination device 115 includes a plurality of visual indicators 140 that provide a plurality of visual representations 150 to a user. An exemplary embodiment of the visual indicators are light-emitting diodes (LEDs). Of course, the illumination device can include other visual indicators (e.g., bulbs, etc.) known those in the art.

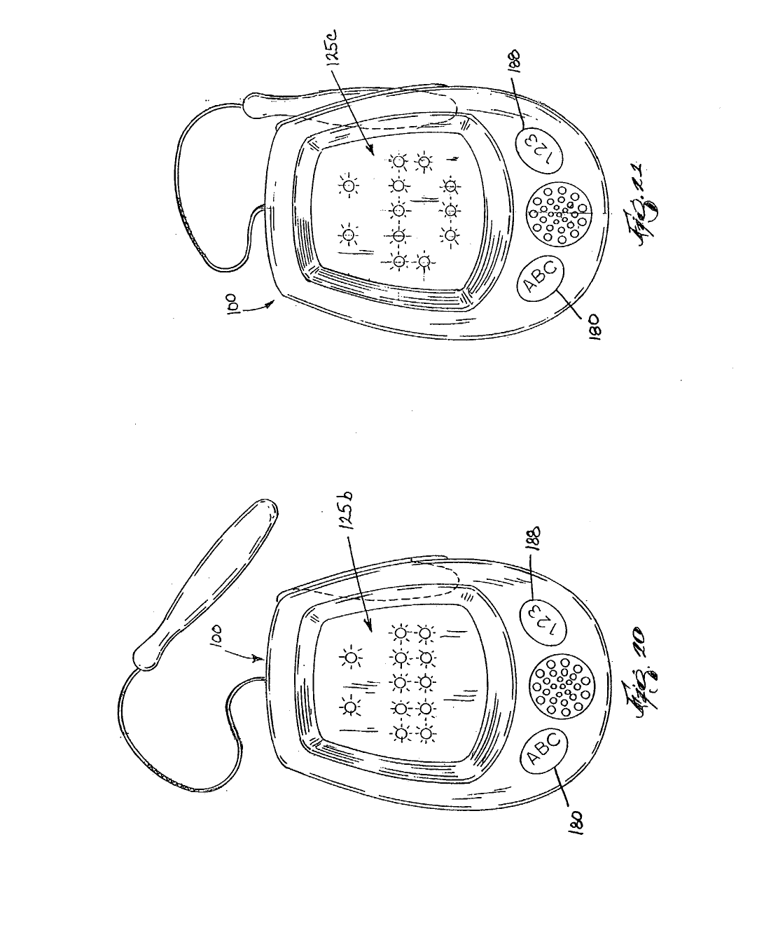

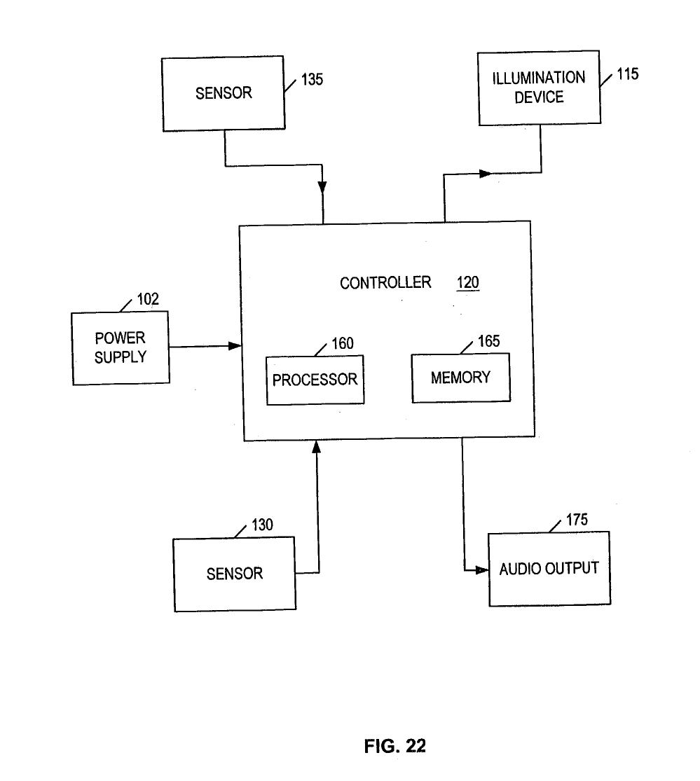

As noted above, the illumination device 115 provides a plurality of visual representations 150 to the user. One embodiment of a visual representation 150 is a pattern of illumination of the visual indicators 140 according to pre-programmed instruction stored in the controller 120. The pattern can include letters of the alphabet, Arabic numerals, animated characters, fireworks, or facial expressions, etc. The visual representations 150 enhance the play value and learning experience offered by the apparatus 100. FIGS. 19-21 illustrate three embodiments of visual representations 150 provided to the user. FIG. 19 illustrates a visual representation 150a of letter “B.” Of course, the visual representation 150 can be any letter of the alphabet or any Arabic numeral. FIGS. 20 and 21 illustrate a visual representation of an animated smiling face to the user with its mouth closed 150b and open 150c, respectively. These two visual representations 150b and 150c can be used in combination to simulate a face interacting or speaking to the user. In another embodiment, a visual representations 150 can include a series of letters to spell a word. In another embodiment, the visual representations 150 can include letters and/or numbers in a foreign language (e.g., Spanish, German, Italian, etc.). In yet another embodiment, a series of visual representations can include a letter of the alphabet in English followed by the letter translated in one or more foreign languages. Other visual representations 150 (e.g., fireworks, etc.) can be used to enhance the play value of the apparatus 100 as well as to indicate the completion of a learning lesson.

In general, the controller 120 communicates with and controls the learning apparatus 100. The controller 120 is electrically connected to a power supply 102, the sensors 130 and 135, and the illumination device 115. For example, in response to a signal from the sensor 130, the controller 120 activates the illumination device 115 to provide at least one visual representation 150. For the embodiment shown in FIG. 16, the controller 120 is mounted on a circuit board 155. As shown in FIG. 22, one embodiment of the controller 120 includes a microprocessor 160 and a memory 165. The memory 165 includes storage for programming instructions for a plurality of visual representations 150 for display by the illumination device 115. In another embodiment, the controller 120 can include a combination of integrated circuitry and/or discrete circuit elements known to those in the art.

In the embodiment as shown in FIGS. 16-18, the display-learning apparatus 100 can further include a stylus 170. The stylus 170 is designed for easy grasping, as well as engaging the display panel with the simulation of a writing device. One embodiment of the stylus 170 is comprised of plastic material. Of course, any type of material (e.g., wood, metal) in other shapes (e.g., pencil, etc.) can be used.

As shown in FIG. 22, the learning apparatus 100 can further include an audio output 175 electrically connected to the controller 120. In response to moving the display panel 112, the controller 120 activates the audio output 175 to provide a plurality of audio sounds pre-programmed into the memory 165 of the controller 120. In combination with the numerous visual representations described above, the audio sounds can include pronunciation of a plurality of sounds for letters, numbers, and words in English or a foreign language, as well as fireworks, giggling, etc. As shown in FIG. 18, one embodiment of the audio output 175 is a speaker. Of course, other known audio outputs known to those in the art can be used.

As shown in FIGS. 16 and 18, the learning apparatus 100 can further include a first button or selector 180 positioned adjacent to a third sensor 185 electrically connected to the controller 120. Pressing the first button 180 engages the third sensor 185, triggering a signal to the controller 120 to provide a series of visual representations 150 from the plurality of preprogrammed visual representations. In one embodiment, pressing the first button 180 initiates a first series of letters of the alphabet. Of course, any type of individual or series of visual representations described herein can be provided to the user. One embodiment of the third sensor 185 is similar to sensor 130 described above.

As shown in FIGS. 16 and 18, the learning apparatus 100 can further include a second button or selector 188 positioned adjacent to a fourth sensor 190 electrically connected to the controller 120. Pressing the second button 188 engages the fourth sensor 190, triggering a signal to the controller 120 to provide a series of visual representations 150. In one embodiment, moving the second button causes a series of visual representations of Arabic numbers. Of course, moving the second button can cause other visual representations 150 as described above. One embodiment of the sensor 190 is similar to sensor 130 described above.

In another embodiment of the learning apparatus 100, the controller 120 includes an internal clock that times out operation of the apparatus 100 and resets the controller 120 after a threshold time interval without detecting movement of the display panel 112 or buttons 180 and 188. In one embodiment, the threshold time interval is ten seconds, but of course this time interval can vary.

Having described the basic architecture of the learning apparatus 100, the operation of the learning apparatus 100 will now be described.

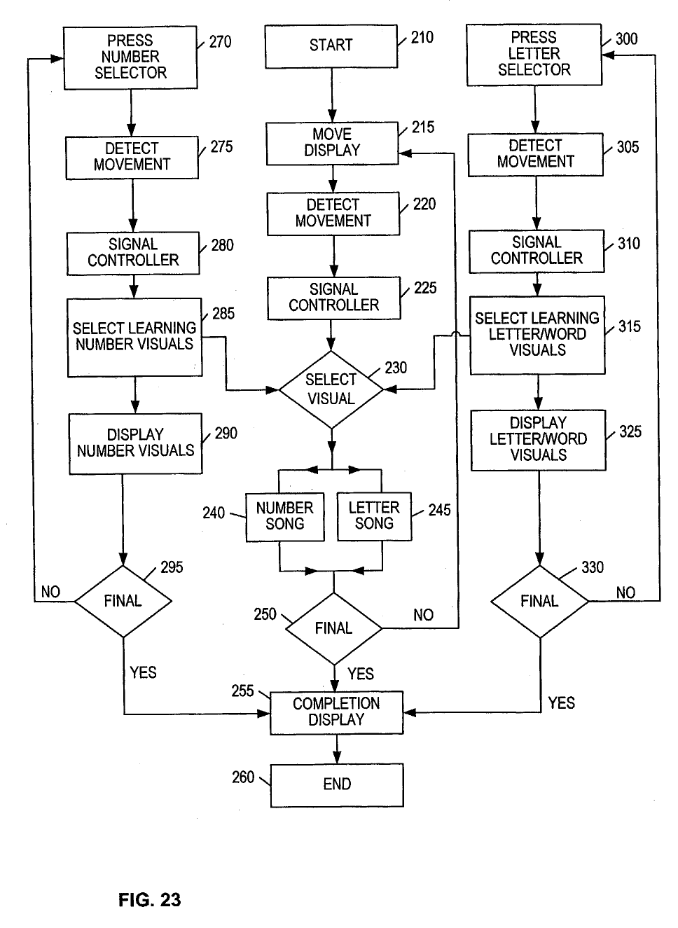

As shown in FIG. 23 and at act 210, the user starts or activates the learning apparatus 100. At act 215, the user moves the display panel 112 to initiate a response from the learning apparatus 100. At act 220, the sensor 130 detects the moving display panel 112. At act 225, the sensor 130 provides a signal to the controller 120.

At act 230, the controller 120 selects from the two learning modes: learning numbers or learning letters of the alphabet. In one embodiment, the default learning mode is for numbers. Based upon the selected learning mode, the controller 120 will select from the preprogrammed visual representations and audio sounds to provide to the user. In one embodiment, the initial series of visual representations includes a combination of animated faces 150b and 150c greeting the user with moving lips in combination with an audio sound of a greeting. The controller 120 then provides a series visual representations 150 and audio sounds for learning numbers. At act 240, the controller 120 provides a series of visual representations 150 in combination with audio sounds for five consecutive numbers in a song format. At act 245, the controller 120 provides a series of visual representations 150 in combination with audio sounds for seven successive letters of the alphabet in a song format.

At act 250, the controller determines whether the visual representation was the last for the successive series of numbers or letters. If yes, then the controller 120 displays a visual representation for congratulating the user for completion of the lesson for learning numbers or letters of the alphabet. Act 260 is the end of the lesson and the controller 120 resets and the apparatus 100 goes into a sleep mode until a movement is detected. If there are more in the succession of visual representations 150, then the controller 120 returns to act 215 and waits for another movement of display panel 112. Upon detecting subsequent movements of the display panel 112, the controller 120 will provide more visual representations 150 of the successive series of numbers and/or letters until the end. One embodiment of the visual representations 150 for learning numbers includes the succession of numbers from one through ten. Of course, the visual representations 150 can include more successive numbers and is not limiting on the invention. One embodiment of the visual representations 150 for learning letters of the alphabet includes all twenty-six letters.

The selector buttons 180 and 188 provide additional acts for the method 200 for learning with a display responsive apparatus 100. For example, the user may desire a lesson for learning numbers. At act 270, the user can press the selector button 180 that selects the learning mode for tracing numbers. At act 275, the switch 190 detects the pressing of the second button 188. At act 280, the switch 190 provides a signal to the controller 120. At act 285, the controller 120 selects the visual representations 150 for tracing numbers. Additionally, if the next detected movement is of the display panel 112, at act 230 the controller 120 will select the visual representations 150 for the number song of act 240 to provide to the user. At act 290, the controller 120 provides a series of visual representations for successive series of numbers that includes an illumination of the respective number of LEDs, a visual representation of two successive numbers are being traced via successive illumination of the LEDs, along with audio sounds for the numbers. In another embodiment, the user can press the selector button 188 for learning numbers while the visual representations 150 for the number song of act 240 are being provided. In this embodiment, the controller 120 detects at what point in the number song did the user press the number selector 188, interrupts the visual representations at that point, and provides the visual representations 150 for tracing the next two successive numbers at a slower pace as described above for act 290. If the user next moves the display panel 112, the controller 120 continues to provide visual representations for the remaining numbers before the interruption in the song format of act 240. At act 295, if the visual representation 150 is the last in the series, then the controller 120 goes to act 255. Otherwise, if there are successive series of visual representations, the controller 120 returns to act 270 to wait detection of a subsequent movement of selector button 188.

Alternatively, the user can desire learning letters of the alphabet. At act 300, the user presses the selector button 180 for the learning mode for letters of the alphabet. At act 305, the switch 185 detects pressing the selector button 180. At act 310, the switch 185 provides a signal to the controller 120 to go into the alphabetic learning mode. At act 315, the controlling selects the visual representations for tracing letters of the alphabet. At act 325, the controller 120 displays of a series of visual representations 150 related to tracing letters of the alphabet. In one embodiment, the visual representations include a trace of a successive series of letters, in combination with audio sounds for the sound of the letter and the use of the letter in a word. Subsequent movements of the display panel 112 provide successive visual representations of letters 150 of the alphabet in the song format of act 245. Analogous to the embodiment for learning numbers described above, the user can press the selector button 180 while the controller 120 provides the visual representations 150 for learning letters in the song format at act 245. Upon receiving the signal from switch 185, the controller 120 interrupts the song format and switches to visual representations for tracing the letters of the alphabet of act 325 at the point of interruption. If the user moves the panel 112, the controller 120 resumes displaying visual representations for learning letters in the song format for the remaining succession of letters. This ability to change learning modes and the pace of visual representations provides enhanced play value for the method 200 for learning from the apparatus 100.

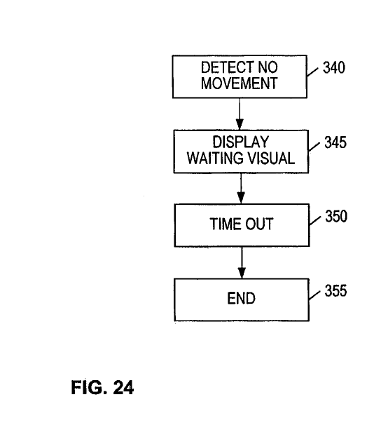

As noted above and shown in FIG. 24, the controller 120 includes an internal clock to detect a threshold time for no movement of the display panel 112 or the selector buttons 180 and 188. At act 340, the controller 120 clocks the time from previous movement until detection of a next movement of the display panel 112 or selector buttons 180 and 188. At act 345, the controller 120 selects at least one visual representation to prompt the user to continue playing with the apparatus 100. In one embodiment, the visual representations 150 include a smiling face with blinking eyes and audio sounds of giggling. At act 350, the controller 120 detects the end of the threshold time without detecting movement the controller 120. At act 355, the controller 120 ends the visual representations 150 and resets itself.

Thus, the invention provides, among other things, a display-responsive learning apparatus and method for children. Various features and advantages of the invention are set forth in the following claims.

It will be understood that various modifications may be made to the embodiments disclosed herein. For example, the writing tablet and housing may be any of a variety of shapes and sizes, as would be known to those of skill in the art. Various combinations of features described herein may or may not be utilized. Also, the writing device may or may not include one or more buttons for activating the output device and various indicia may or may not be provided on the face of the housing. Therefore, the above description should not be construed as limiting, but merely as exemplifications of preferred embodiments. Those skilled in the art will envision other modifications within the scope, spirit and intent of the invention.

What is claimed is:

1. A display-responsive learning apparatus, comprising:
a power supply;
a housing having an aperture;
an illumination device positioned in the aperture and including a plurality of visual indicators operable in providing a plurality of visual representations to a user;
a display panel located in front of the illumination device and rotatable about a hinge member, the display panel including an opaque substrate contrasting the plurality of visual representations of the illumination device;
a sensor positioned to detect moving the display panel and operable in providing a signal in response to the user moving the display; and
a controller electrically connected to the sensor and the illumination device and power supply, wherein response to receiving the signal from the sensor, the controller activates the illumination device to provide at least one of the plurality of visual representations to the user.

2. A display-responsive learning apparatus of claim 1, further comprising a stylus constructed to move the display panel.

3. A display-responsive learning apparatus of claim 1, further comprising a second sensor that triggers the controller to interrupt the visual representation.

4. A display-responsive learning apparatus of claim 1, wherein the sensor is an elastomeric switch mounted to a circuit board supported by the housing.

5. A display-responsive learning apparatus of claim 1, wherein the plurality of visual indicators include light emitting diodes.

6. A display-responsive learning apparatus of claim 1, wherein the plurality of visual representations include pre-programmed visual representations, and wherein the controller includes a storage module for storing the pre-programmed visual representations.

7. A display-responsive learning apparatus of claim 1, further comprising an audio output, where in response to moving the display panel, the controller is operable in activating the audio output to provide a plurality of audio sounds to the user.

8. A display-responsive learning apparatus of claim 1, further comprising a first selector operable in engaging a third sensor electrically connected to the controller, wherein pressing the first selector initiates the controller to provide a series of visual representations related to learning letters of the alphabet.

9. A display-responsive learning apparatus of claim 9, further comprising a second selector operable in engaging a fourth sensor electrically connected to the controller, wherein pressing the second selector initiates the controller to provide a second series of visual related to learning numbers.

10. A display-responsive learning apparatus of claim 1, wherein the controller includes an internal clock that times out operation of the apparatus after a threshold time interval without detecting the user moving the display panel.

11. A method for learning from a display-responsive apparatus, the method comprising the acts of:
storing a plurality of pre-programmed visual representations in a controller;
moving a display panel supported in a housing by a hinge;
detecting movement of the display panel by a sensor;
providing a signal from the sensor to the controller;
providing a signal from the controller to a plurality visual indicators; and
displaying one visual representation from the plurality pre-programmed visual representations with at least one of the plurality of visual indicators to a user.

12. The method of claim 10, wherein the act of displaying includes illuminating a plurality of light-emitting diodes positioned behind an opaque panel.

13. The method of claim 10, the method further comprising the act of providing at least one of a plurality of audio sounds in combination with the act of displaying the one visual representation to the user.

14. The method of claim 14, wherein one of the plurality of pre-programmed visual representations includes a display of a pair of eyes and a pair of lips moving in combination with the at least one audio sound.

15. The method of claim 10, wherein the plurality of pre-programmed visual representations includes a series of successive letters of the alphabet.

16. The method of claim 10, wherein the plurality of pre-programmed visual representations includes a series of successive Arabic numerals.

17. The method of claim 10, wherein a first act of moving the display panel causes the act of displaying a first series of visual representations, and a second act of moving the display panel causes an act of displaying a second series of visual representations in succession to a first series of visual representations.

18. The method of claim 10, the method further comprising the act of selecting between visual representations of letters and visual representations of Arabic numerals..

19. A touch responsive learning device, comprising:
means for pivotally supporting a display panel;
means for detecting movement of the display panel;
means for storing a plurality of pre-programmed visual representations;
means for selecting from a plurality of pre-programmed visual representations; and
means for illuminating at least one of a plurality light emitting diodes to provide one of the plurality of pre-programmed visual representations to a user.
